(19) United States
(12) Patent Application Publication
(10) Pub. No.: US 2026/0120511 A1
(43) Pub. Date: Apr. 30, 2026

(54) OBJECT BEHAVIOR RECOGNITION

(71) Applicant: Shenzhen Oceanwing Smart Innovations Technology Co., Ltd., Shenzhen (CN)

(72) Inventors: Weizhong Jiang, Shenzhen (CN); Lei Chen, Shenzhen (CN)

(21) Appl. No.: 18/911,743

(22) Filed: Oct. 10, 2024

(30) Foreign Application Priority Data
Jun. 7, 2024 (CN) 202410745041.7

(51) Int. Cl. G06V 40/20; G06F 3/04817; G06F 3/0486; G06T 7/20; G06V 10/77; G06V 20/52

(52) U.S. Cl. CPC G06V 40/20; G06F 3/04817; G06F 3/0486; G06T 7/20; G06V 10/7715; G06V 20/52; G06T 2207/30241; G06V 2201/07

(57) ABSTRACT

The present application relates to an object behavior recognition method and a setting method for behavior recognition. The object behavior recognition method comprises: obtaining an image of a target object within a preset area, and determining a movement distance and a movement end position of the target object within the preset area according to the image; determining whether the movement distance is greater than or equal to a preset first distance threshold, and determining whether the movement end position is within a preset end area; and determining a correspondence between a current behavior of the target object and a target behavior type after determining that the movement distance is greater than or equal to the first distance threshold and the movement end position is within the end area. Therefore, whether an object behavior corresponds to the target behavior type can be recognized and a notification can be generated.

The present application claims priority to CN Application No. 202410745041.7, filed on Jun. 7, 2024. The above application is incorporated by reference in its entirety.

### TECHNICAL FIELD

The present application relates to the technical field of object recognition, and in particular to an object behavior recognition method and a method for setting behavior recognition.

### BACKGROUND

Nowadays, family safeguarding is an important theme in the home security industry, and accurately assessing events occurring near the home is one of the important ways to ensure home protection.

However, there are many uncertainties in behavior assessment related to home protection, such as multiple routes to return home, or poor signals or low battery power of a device carried by a target performing a specific behavior. These factors can lead to inaccurate behavior recognition, resulting in misjudgment or an inability to make judgements, which negatively affects user experience.

### SUMMARY

The present application provides an object behavior recognition method and a method for setting behavior recognition to address the technical problems of inaccurate behavior recognition, misjudgment or the inability to make judgement in home protection that negatively affect user experience.

In a first aspect, the present application provides an object behavior recognition method, including:
obtaining an image of a target object within a preset area, and determining a movement distance and a movement end position of the target object within the preset area according to the image;
determining whether the movement distance is greater than or equal to a preset first distance threshold, and determining whether the movement end position is within a preset end area;
determining a correspondence between a current behavior of the target object and a target behavior type after determining that the movement distance is greater than or equal to the first distance threshold and the movement end position is within the end area; and
sending a notification associating the target behavior type with the target object based on the determined correspondence.

In a second aspect, the present application provides an object behavior recognition method, including:
obtaining an image of a target object within a preset area, and determining a movement start position and a movement end position of the target object within the preset area according to the image; and
recognizing that a current behavior of the target object corresponds to a target behavior type after determining that the movement start position is within a preset start area and the movement end position is within a preset end area.

In a third aspect, the present application provides a setting method for behavior recognition, including:
obtaining a captured image of a preset area and displaying the captured image;
determining a preset start position and a preset end position of a target behavior type set for the captured image; and
determining a distance threshold corresponding to the target behavior type according to the preset start position and the preset end position, for recognizing, according to the distance threshold and the preset end position, whether an object behavior corresponds to the target behavior type.

In a fourth aspect, the present application provides another setting method for behavior recognition, including:
obtaining a captured image of a preset area and displaying the captured image;
determining a movement trajectory of a target behavior type set for the captured image; and
determining a distance threshold and an end area corresponding to the target behavior type according to the movement trajectory, for recognizing, according to the distance threshold and the end area, whether an object behavior corresponds to the target behavior type.

In a fifth aspect, the present application provides a setting method for behavior recognition, including:
obtaining a captured image of a preset area and displaying the captured image;
determining a preset start position and a preset end position of a target behavior type set for the captured image; and
determining a start area and an end area respectively according to the preset start position and the preset end position, for recognizing, according to the start area and the end area, whether an object behavior corresponds to the target behavior type.

In a sixth aspect, the present application provides an electronic device, including: a processor, a memory, and a communication interface, where the communication interface is configured to transmit data information through a local area network or a connection circuit, and the memory is configured to store the data information;
the processor is configured to process the data information to generate information indicating a movement distance and a movement end position of a target object within a preset area;
the processor is further configured to generate, according to the information indicating the movement distance and the movement end position of the target object within the preset area, information used for determining that a current behavior of the target object corresponds to a target behavior type; and
the communication interface is further configured to send, to a terminal device, the information indicating the target behavior type.

In a seventh aspect, the present application provides an electronic device, including: a controller, a storage medium, a communication interface, and a display interface, where the communication interface is configured to transmit data information through a local area network or a connection circuit, and the storage medium is configured to store the data information;
the controller is configured to process the data information to generate information indicating a captured image of a preset area;
the display interface is configured to display the information about the captured image of the preset area and receive information about a preset start position and a preset end position of a target behavior type set for the captured image;
the controller is further configured to generate, according to the information about the preset start position and preset end position of the target behavior type set for the captured image, information that can be used for determining the preset start position and preset end position of the target behavior type set for the captured image;
the controller is further configured to generate, according to the information indicating the preset start position and preset end position of the target behavior type set for the captured image, information used for indicating a distance threshold corresponding to the target behavior type; and
the communication interface is further configured to send, to a camera or a base station, the information indicating the distance threshold and a threshold end position.

According to the technical solution provided in the embodiments of the present application, an image of a target object within a preset area is obtained, a movement distance and a movement end position of the target object within the preset area are determined according to the image, whether the movement distance is greater than or equal to a preset first distance threshold is determined, whether the movement end position is within a preset end area is determined, and it is determined that a current behavior of the target object corresponds to a target behavior type when the movement distance is greater than or equal to the first distance threshold and the movement end position is within the end area. Based on the correspondence, the target behavior type is set to be associated with the target object. In the technical solution, whether the behavior of the target object corresponds to the target behavior type is determined by obtaining the movement image of the target object within the preset area and recognizing whether the movement distance and movement end position of the target object in the image satisfy conditions of the preset target behavior type, without relying on external devices and without obtaining a movement trajectory of the object beyond the preset area. Because the preset area is area region through which the behavior corresponding to the target behavior type occurs, this prevents the situation where a change in the movement trajectory of the object leads to an inability to assess the object's behavior. It enables fast and accurate recognition of whether the object's behavior belongs or corresponds to the target behavior type.

### BRIEF DESCRIPTION OF THE DRAWINGS

The accompanying drawings herein are incorporated into the description and constitute a portion of the description, show embodiments consistent with the present invention, and are used together with the description for explaining the principle of the present invention.

In order to describe the technical solutions in the embodiments of the present invention or in the prior art more clearly, the following briefly introduces the accompanying drawings required for use in the text of the embodiments or the prior art. Apparently, those of ordinary skill in the art can derive other drawings from these drawings without any creative effort.

One or more embodiments are exemplified by corresponding drawings. These exemplified descriptions do not constitute limitations on the embodiments. The elements with the same reference numerals in the drawings are denoted as similar elements. Unless otherwise stated, the drawings do not constitute proportional limitations.

FIG. 1 is a schematic diagram of an application scenario for an object behavior recognition method provided in an embodiment of the present application;

FIG. 2 is a flowchart of an object behavior recognition method provided in an embodiment of the present application;

FIG. 3 is a flowchart of another object behavior recognition method provided in an embodiment of the present application;

FIG. 4 is a flowchart of still another object behavior recognition method provided in an embodiment of the present application;

FIG. 5 is a flowchart of yet another object behavior recognition method provided in an embodiment of the present application;

FIG. 6 is a flowchart of yet another object behavior recognition method provided in an embodiment of the present application;

FIG. 7 is a flowchart of a setting method for behavior recognition provided in an embodiment of the present application;

FIG. 8A is a schematic diagram of a captured image provided in an embodiment of the present application;

FIG. 8B is a schematic diagram of another captured image provided in an embodiment of the present application;

FIG. 9 is a flowchart of another setting method for behavior recognition provided in an embodiment of the present application;

FIG. 10 is a flowchart of still another setting method for behavior recognition provided in an embodiment of the present application;

FIG. 11 is a flowchart of a further object behavior recognition method provided in an embodiment of the present application;

FIG. 12 is a schematic structural diagram of an object behavior recognition system provided in an embodiment of the present application;

FIG. 13 is a schematic structural diagram of an electronic device provided in an embodiment of the present application; and

FIG. 14 is a schematic structural diagram of another electronic device according to an embodiment of the present application.

### DETAILED DESCRIPTION

In order to make the objectives, technical solutions and advantages of the embodiments of the present application clearer, the technical solutions in the embodiments of the present application will be described clearly and completely below in conjunction with the accompanying drawings therein. Apparently, the described embodiments are some of the embodiments of the present application, not all of them. Based on the embodiments of the present application, all other embodiments obtained by those of ordinary skill in the art without any creative effort shall fall within the scope of protection of the present application.

The following disclosure provides many different embodiments or examples for implementing different structures of the present invention. In order to simplify the disclosure of the present invention, the components and settings of specific examples are described below. Of course, they are only examples and are not intended to limit the present invention. In addition, the present invention can repeatedly refer to numbers and/or letters in different examples. The repetition is for the purpose of simplification and clarity, and does not indicate the relationship between various discussed embodiments and/or settings.

In order to address the technical problems of inaccurate behavior recognition, misjudgment or the inability to make judgement in home protection that negatively affect user experience, the present application provides an object behavior recognition method and a setting method for behavior recognition, which can determine whether a behavior of a target object belongs or corresponds to a target behavior type by obtaining a movement image of the target object within a preset area and recognizing whether a movement distance and a movement end position of the target object in the image satisfy conditions of the preset target behavior type, without relying on an external device or without obtaining a movement trajectory of the object beyond the preset area. Because the preset area is an area that the behavior corresponding to the target behavior type occurs, this prevents the situation where a change in the movement trajectory of the object leads to an inability to assess the object's behavior. It enables fast and accurate recognition of whether the object behavior corresponds to the target behavior type.

For the convenience of understanding the object behavior recognition method provided in the present application, the following first illustrates an application scenario involved in the present application.

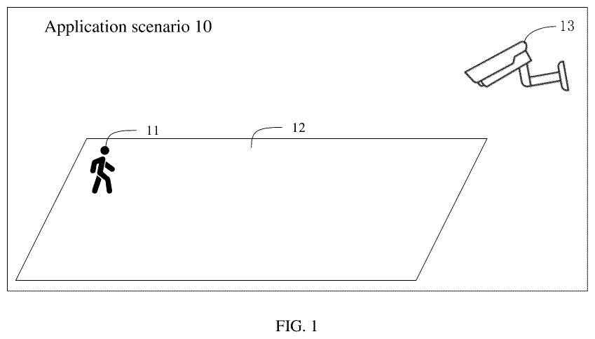

Refer to FIG. 1, which is a schematic diagram of an application scenario for an object behavior recognition method provided in an embodiment of the present application. As shown in FIG. 1, the application scenario 10 may include: an object 11, a preset area 12, and a camera module 13.

The object 11 refers to an object that enters the preset area 12 for behavior recognition, and may be a preset target object. For example, when the application scenario 10 is a home scenario, the target object may be a family member. For another example, when the application scenario 10 is a work scenario, the target object may be a company employee. The embodiment of the present application does not limit this.

The preset area 12 refers to a preset area that the object passes through when the behavior of the object corresponds to a target behavior type. The target behavior type may be a behavior of going home, a behavior of leaving home, a behavior of going to work, an express delivery behavior, or the like of the object. Correspondingly, the preset area may be an area that the object passes through when entering a house door, an area that the object passes through when entering a company, an area that a courier passes through when delivering an express, or the like, which is not limited by the embodiment of the present application.

Taking the behavior of going home as an example, if the object wants to return home, the object can pass through an area in front of the door. Alternatively, if there is a courtyard in user's house, the preset area may be a courtyard area. When the user goes home, the user can go from the entrance of the courtyard to the entrance of the house and then get back home.

The camera module 13 may be a camera or another apparatus with a capturing function, which is not limited by the embodiment of the present application. The camera module 13 can be used for capturing the preset area, and may be installed inside or outside the preset area, which is not limited by the embodiment of the present application.

The camera module 13 can capture all of the preset area 12, or capture a main area of the preset area 12, that is, all of or the main area of the preset area 12 is within the field of view of the camera module 13. The main area may be a portion of the preset area 12 that the target object passes through when the target behavior type is further determined.

In one embodiment, the execution entity in the embodiment of the present application may be the camera module 13 or a base station corresponding to the camera module 13, which is not limited by the embodiment of the present application.

In the embodiment of the present application, the execution entity can obtain an image captured by the camera module 13 within the preset area, and recognize the image to determine whether the movement behavior of the target object within the preset area corresponds to the target behavior type using the object behavior recognition method provided in the present application.

The following provides further explanation of the object behavior recognition method provided in the present application with specific embodiments in conjunction with the accompanying drawings. The embodiments do not constitute limitations on the present invention.

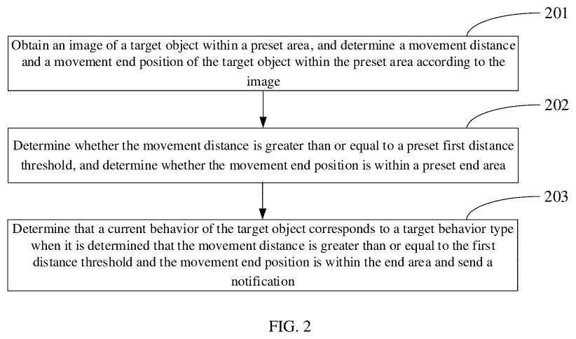

Refer to FIG. 2, which is a flowchart of an object behavior recognition method provided in an embodiment of the present application. As shown in FIG. 2, the flow may include the following steps:
Step 201: Obtain an image of a target object within a preset area, and determine a movement distance and a movement end position of the target object within the preset area according to the image.

The target object refers to a preset object whose behavior needs to be recognized, such as a preset family member.

The preset area refers to an area that the target object passes through when a behavior of the target object corresponds to a target behavior type, such as an entrance area of a house area that the target object passes through or a courtyard area of a house area when a behavior of going home occurs, or an area in front of an express delivery cabinet that the target object passes through when an express delivery behavior occurs.

The movement distance refers to a straight-line distance between a movement start position and the movement end position of the target object within the preset area.

The movement start position is a position where the target object starts moving when entering the preset area, and the movement end position is a position when the target object ends moving or disappears within the preset area.

When the image includes an area object (such as a house door or an express delivery cabinet) within the preset area, the movement end position is a position when the target object ends moving within the preset area, or a position when the target object arrives at a specified position. When the image does not include an area object within the preset area, for example, when the camera module is located on a house door and cannot capture the house door, the camera module cannot capture the end of movement of the target object, so the movement end position is a position when the target object disappears within the preset area.

In one embodiment, there is at least one camera module (such as the camera module 13 shown in FIG. 1) for capturing the preset area. On this basis, the execution entity in the embodiment of the present application can detect the preset area in real time through the camera module, and recognize an object within the preset area when the object is detected out within the preset area. Optionally, if the object within the preset area is recognized as a target object, an image of the target object within the preset area is obtained.

As an optional implementation, the execution entity in the embodiment of the present application can detect the presence of a target object within the preset area by the following way: First, when it is detected that there is an object in a captured image of the camera module, object features of the object in the captured image can be extracted. The object features refer to features that can be used for recognizing the target object, including but not limited to physiological features, appearance features, and posture features, where the physiological features may be features of face, iris, and the like of the object, the appearance features may be corresponding wearing features and the like, and the posture features may include gait, posture and the like of the object. For example, when the object is a courier, the execution entity in the embodiment of the present application can further determine that the object is a target object, namely, the courier, by recognizing object's clothes or courier number.

Afterwards, whether a preset database stores the target object that matches the object features can be determined according to the object features. Optionally, when the target object is matched, it can be determined that there is a target object within the preset area.

In one embodiment, when it is recognized that there is a target object within the preset area, an image of the target object within the preset area can be obtained, and a movement distance and a movement end position of the target object within the preset area can be determined according to the image.

The image may include a multi-frame image involved in the process of movement of the target object within the preset area from the beginning to the end (or disappearance from the captured image within the preset area). On this basis, the execution entity in the embodiment of the present application can determine the movement distance and movement end position of the target object within the preset area from the multi-frame image.

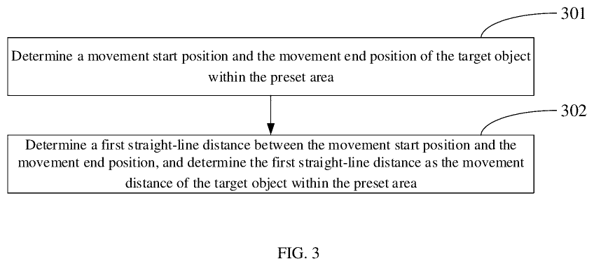

As for how the execution entity in the embodiment of the present application specifically determines the movement distance and movement end position of the target object within the preset area, explanation is provided below through the flow shown in FIG. 3, and detailed description is not provided here.
Step 202: Determine whether the movement distance is greater than or equal to a preset first distance threshold, and determine whether the movement end position is within a preset end area.
Step 203: Determine that a current behavior of the target object corresponds to a target behavior type after determining that the movement distance is greater than or equal to the first distance threshold and the movement end position is within the end area.

The following is an explanation for step 202 and step 203:

The first distance threshold refers to a minimum distance that the behavior corresponding to the target behavior type needs to move within the preset area.

The end area refers to an area where the target object of the behavior corresponding to the target behavior type is located within the preset area when the target object ends moving or disappears from the captured image within the preset area.

The target behavior type refers to a type corresponding to a preset behavior, including but not limited to: a behavior of going home, a behavior of leaving home, a behavior of going to work, an express delivery behavior, etc.

In the embodiment of the present application, in order to more accurately determine whether the current behavior of the target object corresponds to the target behavior type, the execution entity in the embodiment of the present application can recognize the behavior of the target object within the preset area from two aspects: whether the movement distance of the target object within the preset area is greater than or equal to the preset first distance threshold; and whether the end position of the target object within the preset area is within the preset end area. Understandably, the embodiment of the present application does not impose any limitation on the time sequence of determining whether the movement distance is greater than or equal to the first distance threshold and whether the end position is within the end area.

Regarding the movement distance, it can be seen from the above description that the movement distance is a straight-line distance between the movement start position and movement end position of the target object within the preset area. Therefore, when the movement distance is greater than or equal to the first distance threshold, it can exclude the situation where the target object returns to the target area (such as home) due to temporary activities, wandering, staying, or playing.

Further, the first distance threshold can be determined by the following way: determining a minimum distance between a preset start position and the preset end area, and designating the minimum distance as the first distance threshold. The preset start position can be determined by responding to the setting of a start position of the target behavior type, that is, a user can preset a start position of the behavior corresponding to the target behavior type.

Regarding the end position, due to different movement directions of the target object, final movement end positions are also different. Therefore, a type of a user behavior can be determined according to the movement end position of the target object. For example, when the user experiences the behavior of going home, the movement end position is located near the house door. When the user experiences the behavior of leaving home, the movement end position is located in an area far from the house door.

On this basis, the end area of the behavior corresponding to the target behavior type can be preset. When the movement end position of the target object is located within the preset end area, it can be determined that the current behavior of the target object corresponds to the target behavior type.

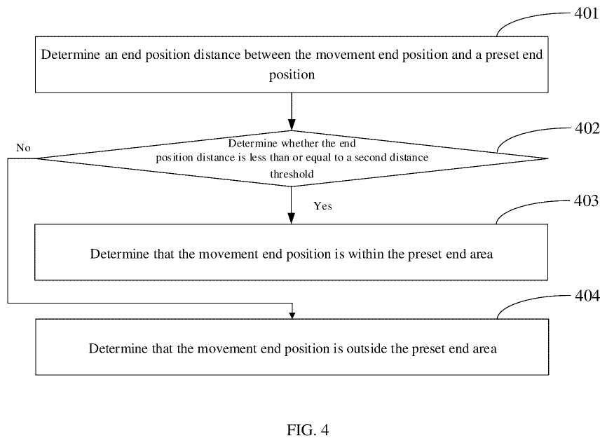

As for how to determine that the movement end position of the target object is within the preset end area, explanation is provided below through the flow shown in FIG. 4, and detailed description is not provided here.

In an embodiment, the target behavior type may include a behavior that the target enters a target area, and the target area is a behavior destination area of the target object (such as a house of the target object, or an area where an express delivery cabinet to which an express is to be delivered is located). On this basis, after it is determined that the current behavior of the target object corresponds to the target behavior type, behavior logs can be generated from videos related to the target behavior type within a preset time period.

In addition, as an exemplary implementation, in order to more efficiently and accurately determine whether the current behavior of the target object corresponds to the target behavior type, the execution entity in the embodiment of the present application can determine a first circle with the center of the end area as a center and the first distance threshold as a radius. On this basis, after determining that the target object moves within the preset area from the circumference of the first circle or a point outside the circumference to the end area, it can be determined that the current behavior of the target object corresponds to the target behavior type.

Moreover, in order to ensure the accuracy of recognition of the object as the target object by the execution entity in the embodiment of the present application, after the target object enters the end area, the execution entity in the embodiment of the present application can recognize the target object again.

As an exemplary implementation, there may be a target camera module for physiological feature recognition within the end area, for example, when the end area includes a door, the target camera module may be a doorbell camera. On this basis, after determining that the object enters the end area, physiological features (such as face and iris features) of the object can be recognized by the target camera module.

Afterwards, whether the preset database stores the target object that matches the physiological features can be determined according to the physiological features. Optionally, it can be determined that there is the target object within the preset area when the matching target object is determined. According to the above method, since the target camera module can detect the physiological features of the object at a short distance, the obtained physiological features are more accurate. Therefore, the target camera module can be used as an auxiliary device for further recognizing the target object to ensure the accuracy of recognition.

In addition, after determining that the current behavior of the target object corresponds to the target behavior type, the execution entity in the embodiment of the present application can send an image and/or prompt information corresponding to the target behavior type of the target object to an external terminal (e.g., a computing device). The prompt information may include at least one of the following information: no other preset target objects are detected within a preset time period, non-target objects enter the preset area, etc. The prompt information may alternatively be a notification of the recognized target behavior type, for example, a child goes home, or a courier from an express company delivers packages.

The external terminal may be a terminal in communication connection with a camera or base station, such as a smart phone. Optionally, the external terminal may be installed with a corresponding application or receive emails to view the behavior of the target object in real time.

For example, when the target object is a family child and the behavior corresponding to the target behavior type is a behavior of going home, and when the camera or base station detects that the child goes home, prompt information that the child goes home can be generated, and the prompt information is sent in a pop-up form to the application installed in the external terminal, or the prompt information is sent by email to the external terminal.

As an exemplary implementation, the user can set a deadline for each target object to experience the behavior corresponding to the target behavior type every day (for example, set the latest time for each target object to return home). On this basis, when determining that the behavior of the target object corresponds to the target behavior type, the execution entity in the embodiment of the present application can record the target object in a preset user table.

Afterwards, a deadline for each preset target object to enter the preset area can be obtained. Upon reaching each deadline, whether there is the target object corresponding to the deadline can be searched in the user table.

Optionally, in the absence of the target object corresponding to the deadline, prompt information can be sent to the preset terminal device, where the prompt information is used for prompting that the deadline has passed and the target user has not experienced the behavior corresponding to the target behavior type.

As an exemplary implementation, after determining that the current behavior of the target object corresponds to the target behavior type, whether the target object is a first preset object can be determined, where the first preset object is a preset object at an age less than a preset age value, such as a family child.

Optionally, after determining that the target object is the first preset object, whether there are other objects in the image of the preset area is determined; and after determining that there are other objects, preset alarm information is sent to the preset terminal, where the other objects refer to objects that are not preset and can be recognized as strangers. In this case, it can be recognized that there is a stranger around when the family child goes home. Therefore, in order to ensure child's safety, alarm information can be sent to the corresponding terminal of the target object to prompt that the family child has been followed and special attention should be paid, thereby ensuring child's safety.

According to the technical solution provided in the embodiments of the present application, an image of a target object within a preset area is obtained, a movement distance and a movement end position of the target object within the preset area are determined according to the image, whether the movement distance is greater than or equal to a preset first distance threshold is determined, whether the movement end position is within a preset end area is determined, and it is determined that a current behavior of the target object corresponds to a target behavior type when the movement distance is greater than or equal to the first distance threshold and the movement end position is within the end area. In the technical solution, whether the behavior of the target object corresponds to the target behavior type is determined by obtaining the movement image of the target object within the preset area and recognizing whether the movement distance and movement end position of the target object in the image satisfy conditions of the preset target behavior type, without relying on external devices and obtaining a movement trajectory of the object beyond the preset area. Because the preset area is an area that the behavior corresponding to the target behavior type occurs, this prevents the situation where a change in the movement trajectory of the object leads to an inability to assess the object's behavior. It enables fast and accurate recognition of whether the object behavior corresponds to the target behavior type.

Refer to FIG. 3, which is a flowchart of another object behavior recognition method provided in an embodiment of the present application. On the basis of the flow shown in FIG. 2, the flow shown in FIG. 3 describes how to determine the movement distance and movement end position of the target object within the preset area. As shown in FIG. 3, the flow may include the following steps:
Step 301: Determine a movement start position and the movement end position of the target object within the preset area.
Step 302: Determine a first straight-line distance between the movement start position and the movement end position, and determine the first straight-line distance as the movement distance of the target object within the preset area.

The following is an explanation for step 301 and step 302:

The movement start position refers to a position when the target object starts moving within the preset area, and correspondingly, the movement end position refers to a position when the target object ends moving within the preset area or disappears from the captured image of the preset area.

The first straight-line distance refers to a straight-line distance between the movement start position and the movement end position, namely, a shortest distance between the two positions.

In the embodiment of the present application, the movement start position and movement end position of the target object within the preset area can be determined by recognizing the image of the target object within the preset area, and the first straight-line distance between the movement start position and the movement end position is determined as the movement distance of the target object within the preset area.

As an exemplary implementation, the execution entity in the embodiment of the present application can obtain a depth of capture field of the camera at the movement start position and determine a starting capture distance between the camera and the movement start position according to the depth of capture field. Similarly, the execution entity can obtain a depth of capture field of the camera at the movement end position and determine an ending capture distance between the camera and the movement end position according to the depth of capture field. On this basis, the first straight-line distance can be determined according to the starting capture distance and the ending capture distance.

As another exemplary implementation, the camera may be installed with a distance sensor (including but not limited to: an optical distance sensor, an infrared distance sensor, an ultrasonic distance sensor, etc.). On this basis, the distance sensor can be used to determine a first distance between the camera and the movement start position and a second distance between the camera and the movement end position. Afterwards, the difference between the first distance and the second distance can be obtained as the first straight-line distance.

As another exemplary implementation, the execution entity in the embodiment of the present application can obtain start coordinates of the movement start position and end coordinates of the movement end position and then directly calculate the start coordinates and the end coordinates to obtain the first straight-line distance.

As an optional implementation, the execution entity in the embodiment of the present application can obtain a movement trajectory of the target object within the preset area and determine a movement start point and a movement end point of the target object on the movement trajectory, so as to determine the movement start point as the movement start position of the target object within the preset area, and to determine the movement end point as the movement end position of the target object within the preset area.

As an exemplary implementation, an image of the target object within the preset area (which may be a movement video of the target object within the preset area) can be input into a pre-trained movement trajectory extraction model, so that the movement trajectory extraction model extracts the movement trajectory of the target object within the target area from the image.

Further, the movement trajectory extraction model may include: N spatial-temporal graph convolutional layers and at least one classifier, where the spatial-temporal graph convolutional layers may include graph convolution and spatial-temporal convolution. On this basis, when the movement trajectory of the target object within the preset area is extracted using the pre-trained movement trajectory extraction model, spatial features of key points of the target object in the image and temporal features at different frames can be extracted using the N spatial-temporal graph convolutional layers, where the spatial features are extracted by the graph convolution, the temporal features are extracted by the spatial-temporal convolution, and key points of the limbs of the target object are uniformly processed when the spatial features are extracted by the graph convolution.

The uniform processing may refer to cancellation on edge weights of a model, that is, when an object model of the target object is determined, an edge weight is determined for an edge of a model corresponding to the limbs of the target object according to the requirements of the prior art, so that the generated object model matches the target object more closely. In the present application, since the movement trajectory extraction model focuses on extracting the movement trajectory of the target object, fuzzy processing can be used when the object model of the target object is generated, that is, edge weights of edges of the model corresponding to the limbs is canceled, and a relatively simple object model corresponding to the target object (such as a matchstick person) is generated, thereby simplifying the model to reduce the time for processing the model and determining the movement trajectory of the target object within the preset area more quickly.

The spatial features and the temporal features can be classified using the at least one classifier to obtain the movement trajectory of the object model in a target blank image, where the object model is a shape model corresponding to the target object, and the target blank image is a blank image without background corresponding to the image.

In addition, the movement trajectory extraction model can be obtained by training as follows: First, a plurality of sample images including the movement process of the object and a standard movement trajectory of the object corresponding to each sample image are obtained. Afterwards, each sample image can be input into an initial movement trajectory extraction model to obtain a predicted movement trajectory of each sample image output by the initial movement trajectory extraction model. Then, for each sample image, a corresponding loss value of the sample image can be determined according to the standard movement trajectory and predicted movement trajectory of the sample image.

Next, whether a preset convergence condition is satisfied currently can be determined according to the corresponding loss value of each sample image. Optionally, after determining that the convergence condition is satisfied, a pre-trained movement trajectory extraction model is obtained. Optionally, after determining that the convergence condition is not satisfied, the training on the initial movement trajectory extraction model with the sample images continues.

The convergence condition may be that the loss value of each sample image is less than a first preset threshold, or that the quantity of sample images, the loss values of which are less than the first preset threshold, is greater than a second preset threshold. The embodiment of the present application does not limit this.

Further, the initial movement trajectory extraction model may include: N initial spatial-temporal graph convolutional layers and at least one initial classifier, where the initial spatial-temporal graph convolutional layers may include initial graph convolution and initial spatial-temporal convolution. On this basis, when each sample image is input into the initial movement trajectory extraction model to obtain a predicted movement trajectory of each sample image output by the initial movement trajectory extraction model, each sample image can be sequentially input into the N initial spatial-temporal graph convolutional layers, so that the initial graph convolution in each initial spatial-temporal graph convolutional layer extracts initial spatial features of key points of the object in the sample image, and the initial spatial-temporal convolution extracts initial temporal features of the key points of the object in the sample image in different frames. When the initial graph convolution extracts the initial spatial features of the key points of the object, the key points of the limbs of the object are uniformly processed.

The initial spatial features and the initial temporal features can be input into the at least one initial classifier to obtain a predicted movement trajectory of an initial object model output by the at least one initial classifier in a sample blank image, where the initial object model is a shape model corresponding to the object, and the sample blank image is a blank image without background corresponding to the sample image.

Notably, the images and sample images input into the motion trajectory extraction model and the output blank images and sample blank images are all multi-frame images, and the movement process of the shape model of the target object in the blank screen can be clearly observed through video segments composed of the multi-frame images.

According to the technical solution provided in the embodiment of the present application, a movement start position and the movement end position of the target object within the preset area are determined, a first straight-line distance between the movement start position and the movement end position is determined, and the first straight-line distance is determined as the movement distance of the target object within the preset area. In the technical solution, the movement start position and movement end position of the target object within the preset area are determined to determine the movement distance of the target object within the preset area, where the movement distance is a straight-line distance between the two and can directly reflect movement changes of the target object within the preset area, thereby more accurately recognizing whether the movement behavior of the target object within the preset area corresponds to the target behavior type, that is, the movement distance of the target object within the preset area is accurately determined, thereby more accurately determining whether the current behavior of the target object corresponds to the target behavior type.

Refer to FIG. 4, which is a flowchart of still another object behavior recognition method provided in an embodiment of the present application. On the basis of the flow shown in FIG. 2, the flow shown in FIG. 4 describes how to determine whether the movement end position is within a preset end area. As shown in FIG. 4, the flow may include the following steps:
Step 401: Determine an end position distance between the movement end position and a preset end position.
Step 402: Determine whether the end position distance is less than or equal to a second distance threshold, and if so, perform step 403; otherwise, perform step 404.
Step 403: Determine that the movement end position is within the preset end area.
Step 404: Determine that the movement end position is outside the preset end area.

The following is a unified explanation for step 401 to step 404:

The preset end position refers to an end position set by the user for the behavior corresponding to the target behavior type that the target object is to pass through. When the image captured by the camera module includes an area object (such as a door), the preset end position may be a position when the user ends moving. When the image captured by the camera module does not include an area object, the preset end position may be a position when the user disappears from the image within the preset area.

In the embodiment of the present application, the user can preset an end position of the behavior corresponding to the target behavior type, and further, the execution entity in the embodiment of the present application can determine the end area within the preset area according to the preset end position. On this basis, the execution entity in the embodiment of the present application can compare the determined movement end position of the target object with the preset end position, thereby determining whether the target object arrives at the end area of the preset area.

As an optional implementation, the end position distance between the movement end position and the preset end position, namely, a straight-line distance between the two, can be determined.

Afterwards, whether the end position distance is less than or equal to the second distance threshold can be determined. Optionally, if it is determined that the end position distance is less than or equal to the second distance threshold, it can be determined that the movement end position is within the preset end area. On the contrary, if it is determined that the end position distance is greater than the second distance threshold, it can be determined that the movement end position is outside the preset end area.

The second distance threshold can be determined according to at least one historical movement end position of at least one target object in a historical time period.

As an exemplary implementation, a historical movement end position can be obtained, and a historical distance value between the historical movement end position and the preset end position can be determined, where the preset end position can be determined by responding to the setting of an end position of the target behavior type, that is, the preset end position can be set by the user.

Afterwards, the second distance threshold can be determined according to the historical distance value.

Optionally, in the presence of one historical distance value, the historical distance value can be directly determined as the second distance threshold; and in the presence of a plurality of historical distance values, an average or maximum value of the plurality of historical distance values can be determined as the second distance threshold.

According to the above description, it can be inferred that the end area can be a circle or semicircle with the preset end position as a center and the second distance threshold as a radius.

On this basis, when determining whether the movement end position of the target object is within the end area of the preset area, the execution entity in the embodiment of the present application can first determine the second distance threshold and determine a target circle or target semicircle with the preset end position as a center and the second distance threshold as a radius.

Afterwards, whether the movement end position is located on the target circle or target semicircle can be determined, and if so, it can be determined that the movement end position of the target object is within the end area; otherwise, it can be determined that the movement end position of the target object is outside the end area.

As another optional implementation, the execution entity in the embodiment of the present application can determine coordinates of the end area according to coordinates of the preset end position, such as the target circle or target semicircle determined above.

Afterwards, when whether the movement end position is within the preset end area is determined, position coordinates of the movement end position can be obtained, whether the position coordinates are within the coordinates of the end area is determined, and if so, it can be determined that the movement end position is within the preset end area.

According to the technical solution provided in the embodiment of the present application, an end position distance between the movement end position and a preset end position is determined, whether the end position distance is less than or equal to a second distance threshold is determined, and if so, it is determined that the movement end position is within the preset end area; otherwise, it is determined that the movement end position is outside the preset end area. In the technical solution, by comparing the distance between the movement end position of the target object within the preset area and the preset end position with the second distance threshold, whether the movement end position of the target object is within the end area of the preset area can be easily and accurately determined, thereby simply and accurately determining whether the current behavior of the target object corresponds to the target behavior type.

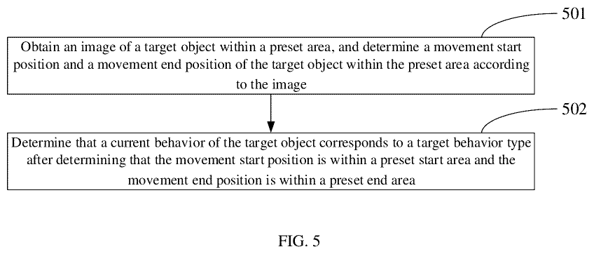

Refer to FIG. 5, which is a flowchart of yet another object behavior recognition method provided in an embodiment of the present application. As shown in FIG. 5, the flow may include the following steps:
Step 501: Obtain an image of a target object within a preset area, and determine a movement start position and a movement end position of the target object within the preset area according to the image.

The target object refers to a preset object whose behavior needs to be recognized, such as a preset family member.

The preset area refers to an area that the target object passes through when a behavior of the target object corresponds to a target behavior type, such as an entrance area of a house area that the target object passes through or a courtyard area of a house area when a behavior of going home occurs, or an area in front of an express delivery cabinet that the target object passes through when an express delivery behavior occurs.

The movement start position is a position where the target object starts moving when entering the preset area, and the movement end position is a position when the target object ends moving or disappears within the preset area.

When the image includes an area object (such as a house door or an express delivery cabinet) within the preset area, the movement end position is a position when the target object ends moving within the preset area, or a position when the target object arrives at a specified position. When the image does not include an area object within the preset area, for example, when the camera module is located on a house door and cannot capture the house door, the camera module cannot capture the end of movement of the target object, so the movement end position is a position when the target object disappears within the preset area. Alternatively, the movement end position may be a designated position area, such as an area designated by the user within the preset area.

In one embodiment, there is at least one camera module (such as the camera module 13 shown in FIG. 1) for capturing the preset area. On this basis, the execution entity in the embodiment of the present application can detect the preset area in real time through the camera module, and recognize an object within the preset area when the object is detected out within the preset area. Optionally, if the object within the preset area is recognized as a target object, an image of the target object within the preset area is obtained.

As an optional implementation, the execution entity in the embodiment of the present application can detect the presence of a target object within the preset area by the following way: First, when it is detected that there is an object in a captured image of the camera module, object features of the object in the captured image can be extracted. The object features refer to features that can be used for recognizing the target object, including but not limited to physiological features, appearance features, and posture features, where the physiological features may be features of face, iris, and the like of the object, the appearance features may be corresponding wearing features and the like, and the posture features may include gait, posture and the like of the object. For example, when the object is a courier, the execution entity in the embodiment of the present application can further determine that the object is a target object, namely, the courier, by recognizing object's clothes or courier number.

Afterwards, whether a preset database stores the target object that matches the object features can be determined according to the object features. Optionally, when the target object is matched, it can be determined that there is a target object within the preset area.

In one embodiment, when it is recognized that there is a target object within the preset area, an image of the target object within the preset area can be obtained, and a movement start position and a movement end position of the target object within the preset area can be determined according to the image.

The image may include a multi-frame image involved in the process of movement of the target object within the preset area from the beginning to the end (or disappearance from the captured image within the preset area). On this basis, the execution entity in the embodiment of the present application can determine the movement start position and movement end position of the target object within the preset area from the multi-frame image.
Step 502: Determine that a current behavior of the target object corresponds to a target behavior type after determining that the movement start position is within a preset start area and the movement end position is within a preset end area.

The start area refers to an area of a start point of a behavior corresponding to the preset target behavior type.

The end area refers to an area where the movement ends or the target object disappears in the behavior corresponding to the preset target behavior type.

In the embodiment of the present application, the execution entity can determine whether the target object moves from the start area to the end area, thereby determining whether the current behavior of the target object corresponds to the target behavior type.

As an optional implementation, whether the movement start position is within the start area can be determined, and whether the movement end position is within the end area can be determined. Optionally, it is determined that the current behavior of the target object corresponds to the target behavior type when the movement start position is within the start area and the movement end position is within the end area.

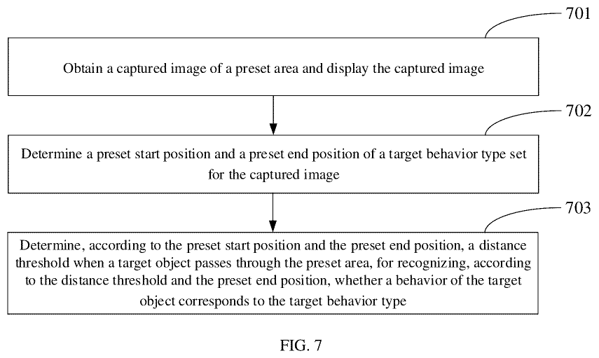

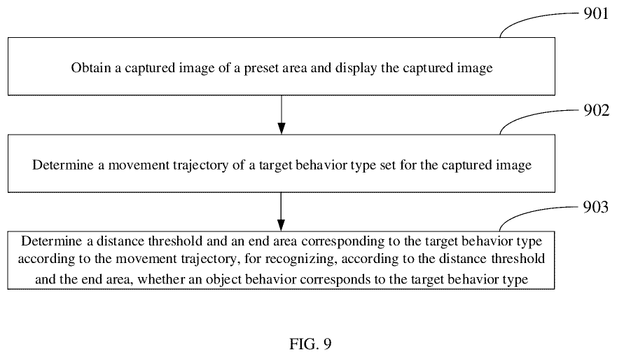

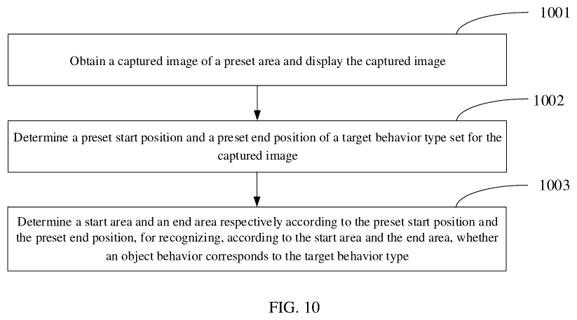

As an exemplary implementation, a start distance between the movement start position and a preset start position can be determined, and an end distance between the movement end position and a preset end position can be determined. The preset start position is determined by responding to the setting of a start position of the target behavior type, and the preset end position is determined by responding to the setting of an end position of the target behavior type. As for methods for determining the preset start position and the preset end position, explanation can be provided below through FIG. 7, FIG. 9, or FIG. 10, and detailed description is not provided here.

Afterwards, after determining that the start distance is less than a third distance threshold and the end distance is less than a fourth distance threshold, it can be determined that the movement start position is within the preset start area and the movement end position is within the preset end area.

The third distance threshold and the fourth distance threshold may be preset distance thresholds, or be determined by the execution entity in the embodiment of the present application according to a plurality of historical start positions and a plurality of historical end positions generated when the object experiences the behavior corresponding to the target behavior type in a historical time period. For example, a maximum distance value among the plurality of historical start positions is determined as the third distance threshold, and a maximum distance value among the plurality of historical end positions is determined as the fourth distance threshold.

In addition, the execution entity in the embodiment of the present application can further determine a movement distance of the target object within the preset area according to the movement start position and the movement end position, then determine whether the movement distance is greater than or equal to a preset first distance threshold, and determine whether the movement end position is within the preset end area. Optionally, when the movement distance is greater than or equal to the first distance threshold and the movement end position is within the end area, it is determined that the current behavior of the target object corresponds to the target behavior type.

As for how to determine the movement distance and how to determine that the movement end position is within the end area, reference may be made to the flow shown in FIG. 2 to FIG. 4 above, and details are not provided here.

According to the technical solution provided in the embodiment of the present application, an image of a target object within a preset area is obtained, a movement start position and a movement end position of the target object within the preset area are determined according to the image, and it is determined that the current behavior of the target object corresponds to a target behavior type when the movement start position is within a preset start area and the movement end position is within a preset end area. In the technical solution, whether the behavior of the target object corresponds to the target behavior type is determined by obtaining the movement image of the target object within the preset area and recognizing whether the movement start position and movement end position of the target object in the image are within the start area and end area respectively, without relying on external devices and obtaining a movement trajectory of the object beyond the preset area. Because the preset area is an area that the behavior corresponding to the target behavior type passes through, failing to determine the behavior of the target object due to changes in the movement trajectory of the object is prevented, and whether the object behavior corresponds to the target behavior type is recognized quickly and accurately.

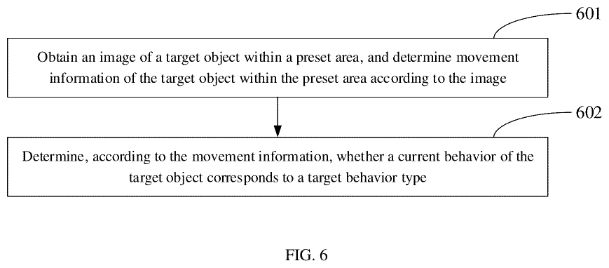

Refer to FIG. 6, which is a flowchart of a further object behavior recognition method provided in an embodiment of the present application. As shown in FIG. 6, the flow may include the following steps:
Step 601: Obtain an image of a target object within a preset area, and determine movement information of the target object within the preset area according to the image.

The target object refers to a preset object whose behavior needs to be recognized, such as a preset family member.

The preset area refers to an area that the target object passes through when a behavior of the target object corresponds to a target behavior type, such as an entrance area of a house area that the target object passes through or a courtyard area of a house area when a behavior of going home occurs, or an area in front of an express delivery cabinet that the target object passes through when an express delivery behavior occurs.

The movement information refers to movement information of the target object within the preset area, which may include but is not limited to: a movement distance, a movement start position, a movement end position, etc. The movement distance refers to a straight-line distance between a movement start position and the movement end position of the target object within the preset area. The movement start position is a position where the target object starts moving when entering the preset area, and the moving end position is a position when the target object ends moving or disappears within the preset area.

When the image includes an area object (such as a house door or an express delivery cabinet) within the preset area, the movement end position is a position when the target object ends moving within the preset area, or a position when the target object arrives at a specified position. When the image does not include an area object within the preset area, for example, when the camera module is located on a house door and cannot capture the house door, the camera module cannot capture the end of movement of the target object, so the movement end position is a position when the target object disappears within the preset area.

In one embodiment, there is at least one camera module (such as the camera module 13 shown in FIG. 1) for capturing the preset area. On this basis, the execution entity in the embodiment of the present application can detect the preset area in real time through the camera module, and recognize an object within the preset area when the object is detected out within the preset area. Optionally, if the object within the preset area is recognized as a target object, an image of the target object within the preset area is obtained.

As an optional implementation, the execution entity in the embodiment of the present application can detect the presence of a target object within the preset area by the following way: First, when it is detected that there is an object in a captured image of the camera module, object features of the object in the captured image can be extracted. The object features refer to features that can be used for recognizing the target object, including but not limited to physiological features, appearance features, and posture features, where the physiological features may be features of face, iris, and the like of the object, the appearance features may be corresponding wearing features and the like, and the posture features may include gait, posture and the like of the object. For example, when the object is a courier, the execution entity in the embodiment of the present application can further determine that the object is a target object, namely, the courier, by recognizing object's clothes or courier number.

Afterwards, whether a preset database stores the target object that matches the object features can be determined according to the object features. Optionally, when the target object is matched, it can be determined that there is a target object within the preset area.

In one embodiment, when it is recognized that there is a target object within the preset area, an image of the target object within the preset area can be obtained, and movement information of the target object within the preset area can be determined according to the image.

The image may include a multi-frame image involved in the process of movement of the target object within the preset area from the beginning to the end (or disappearance from the captured image within the preset area). On this basis, the execution entity in the embodiment of the present application can determine the movement information of the target object within the preset area from the multi-frame image.
Step 602: Determine, according to the movement information, whether a current behavior of the target object corresponds to a target behavior type.

In one embodiment, the execution entity in the embodiment of the present application can determine, according to the movement information, whether the current behavior of the target object corresponds to the target behavior type.

As an optional implementation, the movement information may include a movement distance and a movement end position of the target object within the preset area. On this basis, the execution entity in the embodiment of the present application can determine, according to the movement distance and the movement end position, whether the current behavior of the target object corresponds to the target behavior type.

As for how to determine, according to the movement distance and the movement end position, whether the current behavior of the target object corresponds to the target behavior type, reference may be made to the detailed description of the flow shown in FIG. 2, which will not be repeated here.

As another optional implementation, the movement information may include a movement start position and a movement end position of the target object within the preset area. On this basis, the execution entity in the embodiment of the present application can determine, according to the movement start position and the movement end position, whether the current behavior of the target object corresponds to the target behavior type.

As for how to determine, according to the movement start position and the movement end position, whether the current behavior of the target object corresponds to the target behavior type, reference may be made to the detailed description of the flow shown in FIG. 5, which will not be repeated here.

According to the technical solution provided in the embodiment of the present application, an image of a target object within a preset area is obtained, movement information of the target object within the preset area is determined according to the image, and whether a current behavior of the target object corresponds to a target behavior type is determined according to the movement information. In the technical solution, whether the behavior of the target object corresponds to the target behavior type is determined by obtaining the movement image of the target object within the preset area and recognizing whether the movement information of the target object in the image satisfies conditions of the preset target behavior type, without relying on an external device or without obtaining a movement trajectory of the object beyond the preset area. Because the preset area is an area that the behavior corresponding to the target behavior type passes through, failing to determine the behavior of the target object due to changes in the movement trajectory of the object is prevented, and whether the object behavior corresponds to the target behavior type is recognized quickly and accurately.

Refer to FIG. 7, which is a flowchart of a setting method for behavior recognition provided in an embodiment of the present application. The execution entity of the flow shown in FIG. 7 is different from that shown in FIG. 2 to FIG. 6, and may be a preset terminal. The flow shown in FIG. 7 describes how to set the preset start position and preset end position of the preset area in the flow shown in FIG. 2 to FIG. 6 for the target behavior type. As shown in FIG. 7, the flow may include the following steps:
Step 701: Obtain a captured image of a preset area and display the captured image.

The preset area refers to a preset area that an object passes through when the object experiences a behavior corresponding to a target behavior type.

The captured image refers to an image of the preset area captured by a camera module.

In one embodiment, the execution entity in the embodiment of the present application may be a preset terminal (which may be a terminal device or an application installed in the terminal device, and the embodiment of the present application does not limit this), the preset terminal may be a terminal connected to the execution entity (camera module or base station) of the flow shown in FIG. 2 to FIG. 4, and the terminal can obtain in real time the image of the preset area captured by the camera module and display the captured image through a visual interface, so that a user can perform settings based on the captured image.

In one embodiment, as there may be a plurality of camera modules used for capturing the preset area in practical applications, the execution entity in the embodiment of the present application can obtain a list of camera modules used for capturing the preset area when obtaining the captured image of the preset area and display the list of camera modules.

The user can select a target camera module from the list of camera modules. On this basis, the execution entity in the embodiment of the present application can determine the target camera module from the list of camera modules in response to a camera module selection operation on the list of camera modules and obtain the captured image of the preset area through the target camera module.
Step 702: Determine a preset start position and a preset end position of a target behavior type set for the captured image.

The preset start position refers to a start point of the behavior corresponding to the target behavior type set by the user at the beginning of movement within the preset area.

The preset end position refers to an end point of the behavior corresponding to the target behavior type set by the user at the end of movement within the preset area or at the time of disappearance within the image of the preset area.

When the image captured by the camera module includes an area object (such as a door), the preset end position may be a position when the user ends moving. When the image captured by the camera module does not include an area object, the preset end position may be a position when the user disappears from the image within the preset area.

The target behavior type refers to a type corresponding to a preset behavior, and the preset behavior may be a behavior of going home, a behavior of leaving home, a behavior of going to work, an express delivery behavior, etc.

In the embodiment of the present application, the execution entity can obtain and output the captured image of the preset area. On this basis, the user can set the preset start position and the preset end position corresponding to the target behavior type for the captured image.

On this basis, the execution entity in the embodiment of the present application can determine the preset start position and preset end position of the target behavior type set for the captured image.

As an optional implementation, the user can trigger (double click, single click, long press, or the like) a display screen of the execution entity in the embodiment of the present application, and the execution entity in the embodiment of the present application can output a preset icon in the captured image in response to the user's trigger operation. The preset icon may be a user image of the user who logs in to the execution entity in the embodiment of the present application, or a default icon such as an arrow, a dot, or a circle, which is not limited by the embodiment of the present application.

On this basis, the execution entity in the embodiment of the present application can recognize the preset start position and the preset end position in response to the setting of the preset icon in the captured image.

As an exemplary implementation, the setting of the preset icon may include a click operation. Further, each time the user clicks the captured image, the execution entity in the embodiment of the present application can set a preset icon at the corresponding position of the click operation in response to the user's click operation. On this basis, the user can perform at least two click operations on the captured image. The execution entity in the embodiment of the present application can set a preset icon at the corresponding position of each click operation in response to the at least two click operations on the captured image.

Afterwards, the execution entity in the embodiment of the present application can obtain positions of at least two preset icons clicked by the user and determine the preset start position and the preset end position according to the positions of the preset icons.

Further, optionally, the execution entity in the embodiment of the present application can determine the preset start position and the preset end position according to an order of user clicks, for example, determine the position clicked first as the preset start position and the position clicked later as the preset end position.

Optionally, the execution entity in the embodiment of the present application can output a selection box at each position as a preset start position or a preset end position, and the user can determine to designate the position as the preset start position or the preset end position through the selection box. On this basis, the execution entity in the embodiment of the present application can determine the final preset start position and preset end position according to the user's selection operation.

As another exemplary implementation, the setting of the preset icon may include a drag operation. Further, after the user triggers the captured image and the preset icon is output in the captured image, a movement trajectory of the behavior corresponding to the target behavior type can be drawn in the captured image by dragging the icon. The execution entity in the embodiment of the present application can determine a drag trajectory corresponding to the drag operation in response to the drag operation on the preset icon in the captured image, and recognize a drag start point and a drag end point of the drag trajectory.

Afterwards, the drag start point can be determined as the preset start position of the target behavior type set for the captured image, and the drag end point can be determined as the preset end position of the target behavior type set for the captured image.

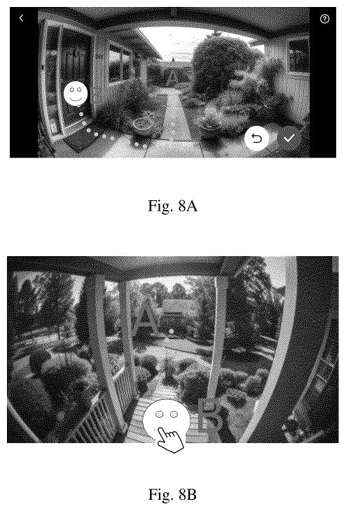

For example, assuming that the behavior corresponding to the target behavior type is a behavior of the target object going home and the camera module connected to the execution entity in the embodiment of the present application is a camera hung high by the user, the captured image obtained by the execution entity in the embodiment of the present application may be as shown in FIG. 8A. Refer to FIG. 8A, which is a schematic diagram of a captured image provided in an embodiment of the present application. Assuming that the camera module connected to the execution entity in the embodiment of the present application is a camera installed on a door, the captured image obtained by the execution entity in the embodiment of the present application may be as shown in FIG. 8B. Refer to FIG. 8B, which is a schematic diagram of another captured image provided in an embodiment of the present application. As shown in FIG. 8, the difference between FIG. 8A and FIG. 8B lies in whether the camera module can capture the position of the door.

As shown in FIG. 8A or FIG. 8B above, after the execution entity in the embodiment of the present application detects out a user's trigger operation, a preset icon can be output in the captured image, and the user can drag the preset icon to draw a movement trajectory of the behavior corresponding to the target behavior type in the captured image, that is, a movement trajectory from point A to point B shown in FIG. 8. On this basis, the drag start point A of the recognized movement trajectory can be determined as the preset start position, and the drag end point B can be determined as the preset end position.

As another optional implementation, the user can capture a video, which may include a movement process of any target object who experiences a behavior corresponding to the target behavior type within the preset area, such as a behavior of going home. Afterwards, the user can send the captured video to the execution entity in the embodiment of the present application.

On this basis, the execution entity in the embodiment of the present application can obtain the input captured video, which may include the target behavior type of behavior of a preset object who experiences within the preset area. Afterwards, the captured video can be analyzed to determine an appearance point and a disappearance point of the preset object in the captured video, the appearance point can be determined as the preset start position of the target behavior type set for the captured image, and the disappearance point can be determined as the preset end position of the target behavior type set for the captured image.

Further, in order to improve the accuracy of the preset start position and the preset end position, the execution entity in the embodiment of the present application can mark the appearance point and the disappearance point in the captured image when recognizing the appearance point and the disappearance point in the captured video, and output prompt information on whether to designate the appearance point as the preset start position and the disappearance point as the preset end position. When the user clicks a confirm button in the prompt information, the execution entity in the embodiment of the present application can determine the appearance point as the preset start position and the disappearance point as the preset end position.
Step 703: Determine a distance threshold corresponding to the target behavior type according to the preset start position and the preset end position, for recognizing, according to the distance threshold and the preset end position, whether an object behavior corresponds to the target behavior type.

The distance threshold refers to a shortest movement distance of the behavior corresponding to the target behavior type within the preset area. That is, if the current behavior of the object corresponds to the target behavior type, its movement distance within the preset area may be greater than or equal to the distance threshold.

In one embodiment, the execution entity in the embodiment of the present application can determine the distance threshold according to the determined preset start position and preset end position, so as to determine whether the behavior of the target object corresponds to the target behavior type in the flow shown in FIG. 2 to FIG. 4 according to the distance threshold and the preset end position.

As an optional implementation, a straight-line distance between the preset start position and the preset end position may be determined as the distance threshold.

Further, after the distance threshold is determined, the distance threshold and the preset end position can be sent to the camera module or a base station of the camera module, so that the camera module or the base station can determine, according to the distance threshold and the preset end position, whether the behavior of the target object corresponds to the target behavior type.

Further, an end area of the behavior corresponding to the target behavior type can be determined according to the preset end position, and the distance threshold and the end area can be sent to the camera module or the base station of the camera module, so that the camera module or the base station can determine, according to the distance threshold and the end area, whether the behavior of the target object corresponds to the target behavior type.

As an exemplary implementation, when the camera module is located outside the area object, there may be the area object in the captured image (for example, when the behavior corresponding to the target behavior type is a behavior of going home, the area object refers to a door used for indicating that the user gets back home; when the target behavior type refers to an express delivery behavior, the area object refers to a delivery cabinet), and the preset end position may be located on the area object; when the camera module is located on the area object, there is no area object in the captured image, and the preset end position is not located on the area object.

On this basis, when the end area of the behavior corresponding to the target behavior type is determined according to the preset end position, whether the preset end position is located on the preset area object can be first determined.

Optionally, after determining that the preset start position is located on the area object, the end area of the behavior corresponding to the target behavior type can be determined with the area object as a center. For example, the end area is a circle with the area object as a center and a first preset distance threshold as a radius.

On the contrary, after determining that the preset start position is not located on the area object, the end area of the behavior corresponding to the target behavior type can be determined with the preset end position as a center. For example, the end area is a circle with the preset end position as a center and a second preset distance threshold as a radius. The first preset distance threshold and the second preset distance threshold may be the same distance threshold or different distance thresholds.

Furthermore, there may be a plurality of target objects in practical applications. Therefore, the execution entity in the embodiment of the present application can output a list of objects, and the user selects a target object for behavior recognition. Afterwards, the target object selected by the user and object features of the target object can be sent to the camera module or the base station, so that the camera module or the base station can recognize whether the behavior of the target object selected by the user corresponds to the target behavior type during object behavior recognition.

As an exemplary implementation, a list of objects can be obtained and displayed. Afterwards, the user can select a target object for behavior recognition from the list of objects.

On this basis, the execution entity in the embodiment of the present application can determine the target object from the list of objects in response to an object selection operation on the list of objects, to recognize whether the behavior of the target object corresponds to the target behavior type.

According to the technical solution provided in the embodiment of the present application, a captured image of a preset area is obtained, the captured image is displayed, a preset start position and a preset end position of a target behavior type set for the captured image are determined, and a distance threshold corresponding to the target behavior type is determined according to the preset start position and the preset end position, for recognizing, according to the distance threshold and the preset end position, whether an object behavior corresponds to the target behavior type. In the technical solution, by displaying the captured image of the preset area in a preset terminal, the user sets the preset start position and the preset end position for the captured image when the target object experiences the behavior corresponding to the target behavior type; and the distance threshold of the behavior corresponding to the target behavior type is determined according to the preset start position and the preset end position, so that the camera module or the base station can recognize the behavior of the target object based on the distance threshold and the preset end position. Therefore, an “immersive” experience and an animation sense are provided, the user is brought into a familiar scenario of going home, and a home trajectory can be quickly and accurately drawn, thereby improving the efficiency and accuracy of object behavior recognition.

Refer to FIG. 9, which is a flowchart of another setting method for behavior recognition provided in an embodiment of the present application. The execution entity of the flow shown in FIG. 9 is different from that in FIG. 2 to FIG. 6, and may be a preset terminal, which may be the same terminal as the flow shown in FIG. 7 or a different terminal. Further, the flow shown in FIG. 9 describes how to set the distance threshold and the end area of the preset area in the flow shown in FIG. 2 for the target behavior type. As shown in FIG. 9, the flow may include the following steps:
Step 901: Obtain a captured image of a preset area and display the captured image.

The preset area refers to a preset area that an object passes through when the object experiences a behavior corresponding to a target behavior type.

The captured image refers to an image of the preset area captured by a camera module.

In one embodiment, the execution entity in the embodiment of the present application may be a preset terminal (which may be a terminal device or an application installed in the terminal device, and the embodiment of the present application does not limit this), the preset terminal may be a terminal connected to the execution entity (camera module or base station) of the flow shown in FIG. 2 to FIG. 6, and the terminal can obtain in real time the image of the preset area captured by the camera module and display the captured image through a visual interface, so that a user can perform settings based on the captured image.

In one embodiment, as there may be a plurality of camera modules used for capturing the preset area in practical applications, the execution entity in the embodiment of the present application can obtain a list of camera modules used for capturing the preset area when obtaining the captured image of the preset area and display the list of camera modules.

The user can select a target camera module from the list of camera modules. On this basis, the execution entity in the embodiment of the present application can determine the target camera module from the list of camera modules in response to a camera module selection operation on the list of camera modules and obtain the captured image of the preset area through the target camera module.
Step 902: Determine a movement trajectory of a target behavior type set for the captured image.
Step 903: Determine a distance threshold and an end area corresponding to the target behavior type according to the movement trajectory, for recognizing, according to the distance threshold and the end area, whether an object behavior corresponds to the target behavior type.

The following is an explanation for step 902 and step 903:

The movement trajectory refers to a trajectory of movement within the preset area when the user experiences the behavior corresponding to the target behavior type.

The target behavior type refers to a type corresponding to a preset behavior, and the preset behavior may be a behavior of going home, a behavior of leaving home, a behavior of going to work, an express delivery behavior, etc.

The distance threshold refers to a shortest movement distance of the behavior corresponding to the target behavior type within the preset area. That is, if the current behavior of the object corresponds to the target behavior type, its movement distance within the preset area may be greater than or equal to the distance threshold.

The end area refers to an area where the movement stops or a disappearance point is located within the preset area when the user experiences the behavior corresponding to the target behavior type.

In the embodiment of the present application, the execution entity can obtain and output the captured image of the preset area. On this basis, the user can set the movement trajectory corresponding to the target behavior type for the captured image.

Afterwards, the distance threshold and the end area corresponding to the target behavior type can be determined according to the movement trajectory, and the distance threshold and the end area can be sent to the camera module or base station of the execution entity shown in FIG. 2 to FIG. 6, so that the camera module or base station can determine, according to the distance threshold or end area, whether the object behavior corresponds to the target behavior type.

As an optional implementation, the user can trigger (double click, single click, long press, or the like) a display screen of the execution entity in the embodiment of the present application, and the execution entity in the embodiment of the present application can output a preset icon in the captured image in response to the user's trigger operation. The preset icon may be a user image of the user who logs in to the execution entity in the embodiment of the present application, or a default icon such as an arrow, a dot, or a circle, which is not limited by the embodiment of the present application.

On this basis, the execution entity in the embodiment of the present application can recognize the movement trajectory of the target behavior type in response to the setting of the preset icon in the captured image.

As an exemplary implementation, the setting of the preset icon may include a drag operation. Further, after the user triggers the captured image and the preset icon is output in the captured image, the movement trajectory of the behavior corresponding to the target behavior type can be drawn in the captured image by dragging the preset icon. The execution entity in the embodiment of the present application can determine a drag trajectory corresponding to the drag operation in response to the drag operation on the preset icon in the captured image.

Afterwards, the execution entity in the embodiment of the present application can determine a preset start position and a preset end position according to the movement trajectory, so as to determine the distance threshold and the end area according to the preset start position and the preset end position.

As an exemplary implementation, a drag start point and a drag end point of the drag trajectory can be recognized, the drag start point can be determined as the preset start position of the target behavior type set for the captured image, and the drag end point can be determined as the preset end position of the target behavior type set for the captured image.

For example, assuming that the behavior corresponding to the target behavior type is a behavior of the target object going home and the camera module connected to the execution entity in the embodiment of the present application is a camera hung high by the user, the captured image obtained by the execution entity in the embodiment of the present application may be as shown in FIG. 8A. Refer to FIG. 8A, which is a schematic diagram of a captured image provided in an embodiment of the present application. Assuming that the camera module connected to the execution entity in the embodiment of the present application is a camera installed on a door, the captured image obtained by the execution entity in the embodiment of the present application may be as shown in FIG. 8B. Refer to FIG. 8B, which is a schematic diagram of another captured image provided in an embodiment of the present application. As shown in FIG. 8, the difference between FIG. 8A and FIG. 8B lies in whether the camera module can capture the position of the door.

As shown in FIG. 8A or FIG. 8B above, after the execution entity in the embodiment of the present application detects out a user's trigger operation, a preset icon can be output in the captured image, and the user can drag the preset icon to draw a movement trajectory of the behavior corresponding to the target behavior type in the captured image, that is, a movement trajectory from point A to point B shown in FIG. 8. On this basis, the drag start point A of the recognized movement trajectory can be determined as the preset start position, and the drag end point B can be determined as the preset end position.

In one embodiment, the execution entity in the embodiment of the present application can determine the distance threshold and the end area according to the determined preset start position and preset end position, so as to determine whether the behavior of the target object corresponds to the target behavior type in the flow shown in FIG. 2 to FIG. 4 according to the distance threshold and the end area.

As an optional implementation, a straight-line distance between the preset start position and the preset end position may be determined as the distance threshold.

Further, when the camera module is located outside the area object, there may be the area object in the captured image (for example, when the behavior corresponding to the target behavior type is a behavior of going home, the area object refers to a door used for indicating that the user gets back home; when the target behavior type refers to an express delivery behavior, the area object refers to a delivery cabinet), and the preset end position may be located on the area object; when the camera module is located on the area object, there is no area object in the captured image, and the preset end position is not located on the area object.

On this basis, when the end area of the behavior corresponding to the target behavior type is determined according to the preset end position, whether the preset end position is located on the preset area object can be first determined.

Optionally, after determining that the preset end position is located on the area object, the end area of the behavior corresponding to the target behavior type can be determined with the area object as a center. For example, the end area is a circle with the area object as a center and a first preset distance threshold as a radius.

On the contrary, after determining that the preset end position is not located on the area object, the end area of the behavior corresponding to the target behavior type can be determined with the preset end position as a center. For example, the end area is a circle with the preset end position as a center and a second preset distance threshold as a radius. The first preset distance threshold and the second preset distance threshold may be the same distance threshold or different distance thresholds.

As another optional implementation, an area formed with the preset start position as a center and the first distance threshold as a radius can be used as the end area, and a distance value from the preset start position to any edge position of the end area can be determined as the distance threshold. The first distance threshold may be a distance value preset by the user.

According to the technical solution provided in the embodiment of the present application, a captured image of a preset area is obtained, the captured image is displayed, a movement trajectory of a target behavior type set for the captured image is determined, and a distance threshold and an end area corresponding to the target behavior type are determined according to the movement trajectory, for recognizing, according to the distance threshold and the end area, whether an object behavior corresponds to the target behavior type. In the technical solution, by displaying the captured image of the preset area in a preset terminal, the user sets the movement trajectory for the captured image when the target object experiences the behavior corresponding to the target behavior type; and the distance threshold and end area of the behavior corresponding to the target behavior type are determined according to the movement trajectory, so that the camera module or the base station can recognize the behavior of the target object based on the distance threshold and the end area, and a home trajectory can be quickly and accurately drawn, thereby improving the efficiency and accuracy of object behavior recognition.

Refer to FIG. 10, which is a flowchart of still another setting method for behavior recognition provided in an embodiment of the present application. The execution entity of the flow shown in FIG. 10 is different from that in FIG. 2 to FIG. 6, and may be a preset terminal, which may be the same terminal as the flow shown in FIG. 7 and FIG. 9 or a different terminal. Further, the flow shown in FIG. 10 describes how to set the start area and end area of the preset area in the flow shown in FIG. 5 for the target behavior type. As shown in FIG. 10, the flow may include the following steps:
Step 1001: Obtain a captured image of a preset area and display the captured image.

The preset area refers to a preset area that an object passes through when the object experiences a behavior corresponding to a target behavior type.

The captured image refers to an image of the preset area captured by a camera module.

In one embodiment, the execution entity in the embodiment of the present application may be a preset terminal (which may be a terminal device or an application installed in the terminal device, and the embodiment of the present application does not limit this), the preset terminal may be a terminal connected to the execution entity (camera module or base station) of the flow shown in FIG. 2 to FIG. 6, and the terminal can obtain in real time the image of the preset area captured by the camera module and display the captured image through a visual interface, so that a user can perform settings based on the captured image.

In one embodiment, as there may be a plurality of camera modules used for capturing the preset area in practical applications, the execution entity in the embodiment of the present application can obtain a list of camera modules used for capturing the preset area when obtaining the captured image of the preset area and display the list of camera modules.

The user can select a target camera module from the list of camera modules. On this basis, the execution entity in the embodiment of the present application can determine the target camera module from the list of camera modules in response to a camera module selection operation on the list of camera modules and obtain the captured image of the preset area through the target camera module.
Step 1002: Determine a preset start position and a preset end position of a target behavior type set for the captured image.
Step 1003: Determine a start area and an end area respectively according to the preset start position and the preset end position, for recognizing, according to the start area and the end area, whether an object behavior corresponds to the target behavior type.

The following is a unified explanation for step 1002 and step 1003:

The target behavior type refers to a type corresponding to a preset behavior, and the preset behavior may be a behavior of going home, a behavior of leaving home, a behavior of going to work, an express delivery behavior, etc.

The preset start position refers to a start point of the behavior corresponding to the target behavior type set by the user at the beginning of movement within the preset area.

The preset end position refers to an end point of the behavior corresponding to the target behavior type set by the user at the end of movement within the preset area or at the time of disappearance within the image of the preset area.

The start area refers to an area of the start point of the behavior corresponding to the preset target behavior type.

The end area refers to an area where the movement ends or the target object disappears in the behavior corresponding to the preset target behavior type.

In the embodiment of the present application, the execution entity can obtain and output the captured image of the preset area. On this basis, the user can set a movement start position and a movement end position corresponding to the target behavior type for the captured image.

On this basis, the execution entity in the embodiment of the present application can determine the preset start position and preset end position of the target behavior type set for the captured image, determine the start area and the end area respectively according to the preset start position and the preset end position, and send the start area and the end area to the camera module or base station of the execution entity shown in FIG. 2 to FIG. 6, so that the camera module or base station can determine, according to the start area or end area, whether the object behavior corresponds to the target behavior type.

As an optional implementation, the execution entity in the embodiment of the present application can determine the preset start position and the preset end position according to a movement trajectory of the target behavior type set for the captured image.

As an exemplary implementation, the user can trigger (double click, single click, long press, or the like) a display screen of the execution entity in the embodiment of the present application, and the execution entity in the embodiment of the present application can output a preset icon in the captured image in response to the user's trigger operation. The preset icon may be a user image of the user who logs in to the execution entity in the embodiment of the present application, or a default icon such as an arrow, a dot, or a circle, which is not limited by the embodiment of the present application.

On this basis, the execution entity in the embodiment of the present application can recognize the movement trajectory of the target behavior type in response to the setting of the preset icon in the captured image.

As an exemplary implementation, the setting of the preset icon may include a drag operation. Further, after the user triggers the captured image and the preset icon is output in the captured image, the movement trajectory of the behavior corresponding to the target behavior type can be drawn in the captured image by dragging the preset icon. The execution entity in the embodiment of the present application can determine a drag trajectory corresponding to the drag operation in response to the drag operation on the preset icon in the captured image, and determine the drag trajectory as the movement trajectory of the target behavior type set for the captured image.

Afterwards, a movement start point and a movement end point of the movement trajectory can be recognized, the movement start point can be determined as the preset start position of the target behavior type set for the captured image, and the movement end point can be determined as the preset end position of the target behavior type set for the captured image.

In one embodiment, the execution entity in the embodiment of the present application can determine a third distance threshold and a fourth distance threshold, determine the start area according to the preset start position and the third distance threshold, and determine the end area according to the preset end position and the fourth distance threshold.

The third distance threshold and the fourth distance threshold may be preset distance thresholds, or be determined by the execution entity in the embodiment of the present application according to a plurality of historical start positions and a plurality of historical end positions generated when the object experiences the behavior corresponding to the target behavior type in a historical time period. For example, a maximum distance value among the plurality of historical start positions is determined as the third distance threshold, and a maximum distance value among the plurality of historical end positions is determined as the fourth distance threshold.

As an optional implementation, an area formed with the preset start position as a center and the third distance threshold as a radius can be used as the start area, and an area formed with the preset end position as a center and the fourth distance threshold as a radius can be used as the end area.

According to the technical solution provided in the embodiment of the present application, a captured image of a preset area is obtained, the captured image is displayed, a preset start position and a preset end position of a target behavior type set for the captured image are determined, and a start area and an end area are determined respectively according to the preset start position and the preset end position, for recognizing, according to the start area and the end area, whether an object behavior corresponds to the target behavior type. In the technical solution, by displaying the captured image of the preset area in a preset terminal, the user sets the preset start position and the preset end position for the captured image when the target object experiences the behavior corresponding to the target behavior type; and the start area and end area of the behavior corresponding to the target behavior type are determined respectively according to the preset start position and the preset end position, so that the camera module or the base station can recognize the behavior of the target object based on the start area and the end area, and a home trajectory can be quickly and accurately drawn, thereby improving the efficiency and accuracy of object behavior recognition.

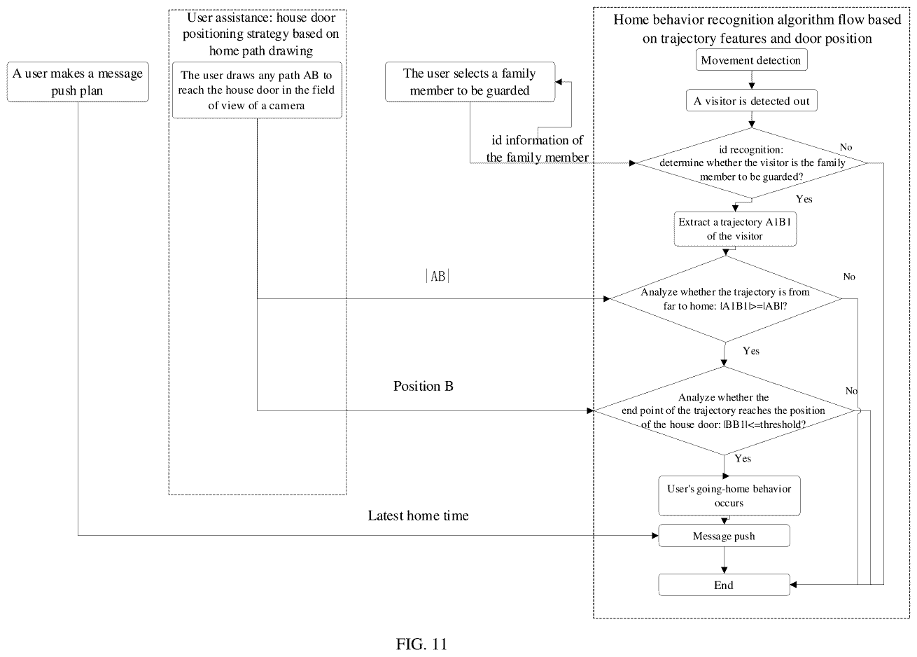

Refer to FIG. 11, which is a flowchart of a further object behavior recognition method provided in an embodiment of the present application. The flow shown in FIG. 11 takes that the behavior corresponding to a target behavior type is a behavior of a target object going home as example, and describes how to set a preset start position and a preset end position and how to recognize the target object. As shown in FIG. 11, the flow may include the following steps:
1. User assistance—house door positioning strategy based on home path drawing.

A user draws a home path to assist an algorithm in positioning a house door. An app interface of a mobile phone displays a field of view image of an outdoor high camera. The user first selects a start point of the home path in the image and then double-clicks a screen to call a character avatar, and the avatar automatically obtains an account avatar of the app. Finally, the user drags the avatar to draw any path AB for going home, where the start point is A and the end point is B. This process occurs in a user setting link. When the drawing ends, a back end of the app records two parameters for a subsequent algorithm to determine a behavior of going home:
(1) Record a necessary length of the user's home path: line segment distance|AB| between A and B;
(2) Record an approximate position of the house door: point B.
2. A home behavior recognition algorithm based on trajectory features and door position.

When a camera detects out a movement event, determination on the behavior of going home begins. The process is as follows:
2.1. Visitor id recognition:

The algorithm first extracts face, posture, and wearing features of a visitor for recognizing id information of the visitor. If the id recognition result is a stranger, the process ends. If the id recognition result determines that the visitor is a to-be-guarded family member set by the user in the phone, the algorithm needs to further determine whether the visitor has engaged in a “going home”behavior.
2.2. Extraction on a complete trajectory of the visitor:

Considering the advantages of a graph neural network in recognizing relationships between different nodes in an image and modeling spatial information of the image, the present invention uses a spatial-temporal convolutional networks (ST-TCN) model to capture spatial-temporal features in a video sequence for modeling an action and trajectory of the visitor. Because the scenario of home recognition is relatively simple, the present invention cancels edge weights of the model to reduce the quantity of parameters by half, thereby effectively reducing the complexity of the model. It is assumed that a trajectory line segment of the visitor in the field of view of the camera, extracted by the ST-TCN model, is A₁B₁, where the trajectory appearance point is A₁, the trajectory disappearance point is B₁, and the distance between the two points is |A₁B₁|.
2.3. Analysis on trajectory features:

In the setting of going-home behavior features, the user passes two pieces of standard information to the algorithm: point B—the position of the house door (visible from the field of view of the camera) or a position close to the house door (invisible from the field of view of the camera), and |AB|—the necessary length of the home path. Based on the standard information, the algorithm needs to analyze the following two:
(1) Analyze whether the trajectory reaches the position of the house door from a distance (process feature of the trajectory):

The algorithm draws a circle with B as a center and |AB|as a radius, denoted as circle B. If a trajectory starts from any point on the circumference of the circle and reaches the center B of the circle, it is determined that the trajectory “reaches the position of the house door from a distance”. Therefore, in the event, the algorithm only needs to determine whether |A₁B₁|>=|AB| is true. If it is true, it is determined that the trajectory is a trajectory “reaches the position of the house door from a distance”.

This feature is a first feature of the behavior of going home, with an advantage of effectively filtering out events of going home after user's temporary activities, wandering, staying, and playing in front of the door or in the courtyard area. Although the trajectory of such events also ends at the position of the house door (assuming that the trajectory is A₂B₂), it is not from far to the house door, namely, |A₂B₂|<|AB|, so the algorithm will not misjudge the behavior.
(2) Analyze whether the end point of the trajectory reaches the position of the house door (result feature of the trajectory):

The user draws the home path to provide the position of the house door. The algorithm determines whether the disappearance point B₁ of the trajectory (A₁B₁) is the position B of the house door. The method of determination is to calculate whether the distance between the two points is less than a threshold, that is, whether |B₁B|<=threshold is true. If it is true, it is determined that the end point of the trajectory reaches the position of the house door.

The threshold is calculated as follows: The algorithm uses the ST-TCN model in 2.2 to extract user's trajectories within a week, designates a disappearance point of these trajectories as Bₙ, and selects a maximum value between Bₙ and B₁: threshold=|Bₙ−B₁|max.

The feature is a second feature of the behavior of going home, with an advantage that the user does not need to set a standard home path. The disadvantage of object behavior recognition in the prior art is that once the user selects a home path different from before, the algorithm will fail. The present invention only focuses on whether the user's path reaches the location of the house door, but does not focus on a specific path to reach the position of the house door. Therefore, even if the user changes the path from the courtyard to the house door, the algorithm can still work properly because it does not rely on a single, fixed home path.
2.4. Result determination:

When the id of the visitor is the set family member, |A₁B₁|>=|AB|, and |B₁B|<=threshold, an event “A family member goes home” is determined. When a family member reaches the center of the circle B in any trajectory from any point on (outside) the circumference of the circle, an event “A family member goes home”is determined.
3. Message push:
3.1. When a set family member fails to go home on time:

The user can set “latest home time” according to different family members. If the system does not recognize a home event of a family member before the “latest home time”, it will push a message notification to a householder through the app, to remind the householder to understand the home situation of the family member in real time and issue an early warning for potential solution time.
3.2. When it is recognized that a child goes home:

For an event that a child goes home: the system recognizes whether the child follows an adult and whether a stranger follows around the child, and sends an alarm message to a preset terminal when the following stranger is determined.

The technical solution provided in the embodiment of the present application can have the following advantages:
1. The behavior of going home is determined through a pure visual algorithm, without relying on positioning of a mobile device/GPS positioning or a task common device, so the recognition on the behavior of going home is not affected by the power, signal, or traffic of the mobile device.
2. The id information of a family visitor is recognized using face and posture fusion features to improve the recognition rate of visitor identity information.
3. Whether a person is “going home” is determined by analyzing whether the trajectory gradually approaches the position of the house, thereby effectively reducing misjudgment caused by the fact that the family member returns to the room after exercising or wandering in the courtyard.
4. Whether a person has “arrived” is determined by analyzing whether the trajectory reaches the position of the house door, and the behavior of going home is determined without relying on a fixed home trajectory, thereby avoiding the situation that the recognition on going home fails when the user changes a conventional home route.

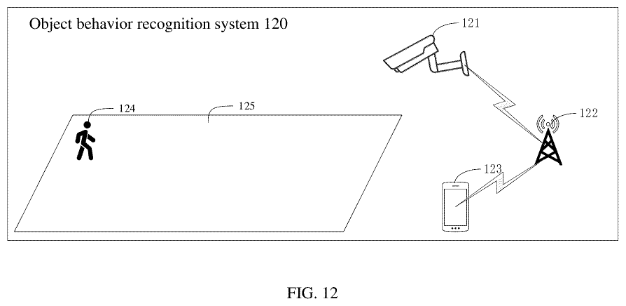

Refer to FIG. 12, which is a schematic structural diagram of an object behavior recognition system provided in an embodiment of the present application. As shown in FIG. 12, the object behavior recognition system 120 may include: a camera module 121, a base station 122, a terminal 123, a target object 124, and a preset area 125.

The camera module 121 may be a camera or another apparatus with a capturing function, such as a security camera or a doorbell camera, which is not limited by the embodiment of the present application. The camera module 121 may be used for capturing the preset area 125, and may be installed inside or outside the preset area, which is not limited by the embodiment of the present application.

The base station 122 may communicate with the terminal 123, the camera module 121, and other indoor home devices (such as a robot cleaner) to serve as a control center, a communication center, or a data processing center. As an embodiment, an image captured by the camera can be used to determine a target behavior type at the camera end and is sent to the terminal 123 by the base station 122, or the captured image can be sent to the base station 122, and the base station 122 determines a target behavior type and then sends the image to the terminal 123.

The terminal 123 may be a PC terminal or a mobile phone terminal, which is not limited by the embodiment of the present application. Further, the terminal 123 may be installed with a corresponding application to set a preset start position and a preset end position of a behavior corresponding to the target behavior type in the flows shown in FIG. 7 and FIG. 9.

In one embodiment, both the camera module 121 and the base station 122 can serve as an executive entity to perform the object behavior recognition method in the flows shown in FIG. 2 to FIG. 6, so as to recognize a current behavior of the target object 124 within the preset area 125.

In one embodiment, the terminal 123 can serve as an executive entity to perform the setting method for behavior recognition in the flows shown in FIG. 7 and FIG. 9.

On this basis, when the object behavior recognition system 120 recognizes the behavior of the target object, the user can set a movement start position and a movement end position of the behavior corresponding to the target behavior type through a page of the application installed in the terminal 123.

As an exemplary implementation, the terminal 123 may obtain an image of the preset area captured by the camera module 121 and output the captured image in a first page. The user can click the captured image to obtain a preset icon, for example, double click the terminal 123 to output a user avatar of user's current login.

Afterwards, the user can move or click the icon to set the movement start position and the movement end position. On this basis, the terminal 123 can determine the preset start position and the movement end position according to the user's click or movement operation.

In one embodiment, the terminal 123 can determine a distance threshold corresponding to the target behavior type according to the preset start position and the preset end position, and send the distance threshold and the movement end position to the camera module 121 or the base station 122, so that the camera module 121 or the base station 122 recognizes, according to the distance threshold and the movement end position, whether the current behavior of the target object corresponds to the target behavior type based on the flow shown in FIG. 2.

In another embodiment, the terminal 123 can directly send the preset start position and the preset end position to the camera module 121 or the base station 122, so that the camera module 121 or the base station 122 recognizes, according to the movement start position and the movement end position, whether the current behavior of the target object corresponds to the target behavior type based on the flow shown in FIG. 6.

Optionally, the application installed in the terminal 123 can further include a second page, the user can set a to-be-recognized target object according to the second page, and the terminal 123 sends object features of the target object to the camera module 121 or the base station 122 after determining the target object, so that the camera module 121 or the base station 122 recognizes, according to the object features, whether the detected object is a target object, and recognizes whether the current behavior of the target object corresponds to the target behavior type when the target object is detected out.

Optionally, the application installed in the terminal 123 can further include a third page. When the object behavior recognition system 120 further includes other camera modules, the user can select, according to the third page, a target camera module for object recognition. For example, the third page can output all the camera modules included in the object behavior recognition system 120. On this basis, the user can select the target camera module from the third page. After receiving the user's selection operation, the terminal 123 can send a corresponding signal to the target camera module, so that the target camera module performs the object behavior recognition method shown in FIG. 2 to FIG. 6.

Optionally, the application installed in the terminal 123 can further include a fourth page, and the user can input a target video through the fourth page, where the target video is about a movement process containing the behavior of the preset object corresponding to the target behavior type. On this basis, the terminal 123 can recognize the target video, thereby determining the preset start position and the preset end position corresponding to the target behavior type.

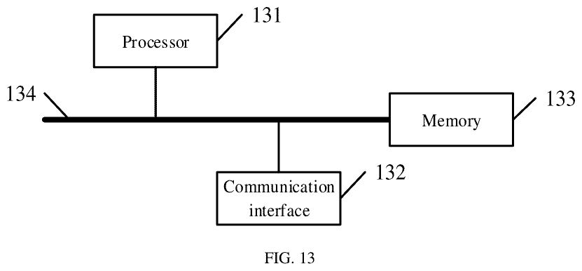

FIG. 13 shows a schematic structural diagram of an electronic device provided in an embodiment of the present application, including a processor 131, a communication interface 132, a memory 133, and a communication bus 134, where the processor 131, the communication interface 132, and the memory 133 communicate with each other through the communication bus 134.

The memory 133 is configured to store a computer program.

In one embodiment of the present application, the processor 131 is configured to implement the object behavior recognition method provided by any of the aforementioned method embodiments when executing the program stored in the memory 133, including:
obtaining an image of a target object within a preset area, and determining a movement distance and a movement end position of the target object within the preset area according to the image;
determining whether the movement distance is greater than or equal to a preset first distance threshold, and determining whether the movement end position is within a preset end area; and
determining that a current behavior of the target object corresponds to a target behavior type after determining that the movement distance is greater than or equal to the first distance threshold and the movement end position is within the end area; or
obtaining an image of a target object within a preset area, and determining a movement start position and a movement end position of the target object within the preset area according to the image; and
determining, according to the movement start position and the movement end position, that a current behavior of the target object corresponds to a target behavior type.

Further, the communication interface 132 is configured to transmit data information through a local area network or a connection circuit, and the memory 133 is configured to store the data information;

The processor 131 is configured to process the data information to generate information indicating the movement distance and movement end position of the target object within the preset area;

The processor 131 is further configured to generate, according to the information indicating the movement distance and movement end position of the target object within the preset area, information used for determining that the current behavior of the target object corresponds to the target behavior type;

The communication interface 132 is further configured to send information indicating the target behavior type to the terminal device.

In one embodiment, the electronic device shown in FIG. 13 may be a camera or a base station.

The terminal 123, the camera module 121, and the base station 122 all have the communication interface 132. The communication interface 132 is configured to achieve local area network connections between the terminal 123, the camera module 121, and the base station 122, including Bluetooth or WIFI. The communication interface 132 can alternatively connect different modules in the electronic device through circuits, such as connect an image sensor with the processor through a circuit to transmit image information to the processor. Therefore, data information can be transmitted to different modules of the same electronic device through the communication interface, or data information can be transmitted to other electronic devices through the communication interface 132, where the data information here includes image information, control information, wireless device activation information, etc., or information, sent to the terminal 123, about a notification of the target behavior type, about that no other preset target objects are detected out in a preset time period or non-target objects enter the preset area, etc. The camera module 121 can transmit an image to the base station 122, the base station 122 sends, to the terminal 123, the information about the notification of the target behavior type, about that no other preset target objects are detected out in the preset time period or non-target objects enter the preset area, etc.

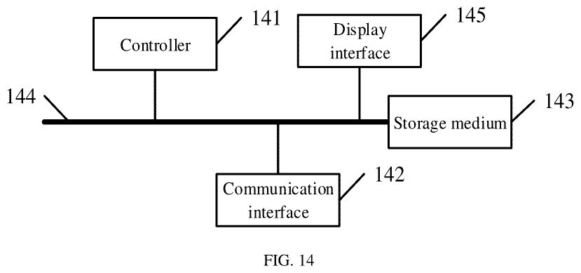

FIG. 14 shows a schematic structural diagram of another electronic device provided in an embodiment of the present application, including a controller 141, a communication interface 142, a storage medium 143, a communication bus 144, and a display interface 145, where the controller 141, the communication interface 142, the storage medium 143, and the display interface 145 communicate with each other through the communication bus 144, and the storage medium 143 is configured to store a computer program.

In one embodiment of the present application, the controller 141 is configured to implement the setting method for behavior recognition provided by any of the aforementioned method embodiments when executing the program stored in the storage medium 143, including:
obtaining a captured image of a preset area and displaying the captured image;
determining a preset start position and a preset end position of a target behavior type set for the captured image; and
determining a distance threshold corresponding to the target behavior type according to the preset start position and the preset end position, for recognizing, according to the distance threshold and the preset end position, whether an object behavior corresponds to the target behavior type;
or
obtaining a captured image of a preset area and displaying the captured image;
determining a movement trajectory of a target behavior type set for the captured image; and
determining a distance threshold and an end area corresponding to the target behavior type according to the movement trajectory, for recognizing, according to the distance threshold and the end area, whether an object behavior corresponds to the target behavior type;
or
obtaining a captured image of a preset area and displaying the captured image;
determining a preset start position and a preset end position of a target behavior type set for the captured image; and
determining a start area and an end area respectively according to the preset start position and the preset end position, for recognizing, according to the start area and the end area, whether an object behavior corresponds to the target behavior type.

In one embodiment, the communication interface 142 is configured to transmit data information through a local area network or a connection circuit, and the storage medium 143 is configured to store the data information;

The controller 141 is configured to process the data information to generate information indicating the captured image of the preset area;

The display interface 145 is configured to display information about the captured image of the preset area and receive information about the preset start position and preset end position of the target behavior type set for the captured image;

The controller 141 is further configured to generate, according to the information about the preset start position and preset end position of the target behavior type set for the captured image, information that can be used for determining the preset start position and preset end position of the target behavior type set for the captured image;

The controller 141 is further configured to generate, according to the information indicating the preset start position and preset end position of the target behavior type set for the captured image, information used for indicating the distance threshold corresponding to the target behavior type;

The communication interface 142 is further configured to send the information indicating the distance threshold and a threshold end position to the camera or base station shown in FIG. 13.

An embodiment of the present application further provides a storage medium, storing a computer program that, when executed by a processor, implements the steps of the object behavior recognition method or the setting method for behavior recognition provided in any of the aforementioned method embodiments.

The device embodiments described above are merely illustrative. The units described as separate components may or may not be physically separated, and the components displayed as units may or may not be physical units, that is, they may be located in one place, or may be distributed to a plurality of network units. Some or all of the modules may be selected according to actual needs to achieve the objectives of the solutions of the embodiments.

Through the text of the above implementations, those skilled in the art can clearly understand that each implementation can be achieved by software and a universal hardware platform, or by hardware. Based on such an understanding, the above technical solutions or the parts that contribute to relevant technologies can be embodied in a form of software products. The computer software product can be stored in a computer-readable storage medium such as an ROM/RAM, a magnetic disc, or an optical disc, and includes a plurality of instructions to enable a camera or a base station to perform the method described in each embodiment or some parts of the embodiment in FIG. 2 to FIG. 6, and a terminal to perform the method described in each embodiment or some parts of the embodiment in FIGS. 7, 9, and 10.

It should be understood that the terms used herein are only for the purpose of specific exemplary implementations and are not intended to be restrictive. Unless otherwise explicitly stated in the context, singular forms such as “a”, “one”, and “the” used herein may also include plural forms. The terms “comprise”, “include”, “contain”, and “have” are inclusive and therefore indicate the existence of the stated features, steps, operations, elements, and/or components, but do not exclude the existence or addition of one or more other features, steps, operations, elements, components, and/or combinations thereof. The method steps, processes, and operations in the text are not interpreted as requiring them to be executed in a specific order specified in the text or description, unless an execution order is clearly indicated. It should also be understood that additional or alternative steps can be used.

The above are merely specific implementations of the present invention, which enable those skilled in the art to understand or implement the present invention. Various modifications to the embodiments are obvious to those skilled in the art, and general principles defined herein can be implemented in other embodiments without departing from the spirit or scope of the present invention. Therefore, the present invention will not be limited to the embodiments described herein, but conforms to the widest scope consistent with the principle and novelty of the present application.

What is claimed is:

1. An object behavior recognition method, comprising:
obtaining an image of a target object within a preset area;
determining a movement distance and a movement end position of the target object within the preset area according to the image;
determining whether the movement distance is greater than or equal to a preset first distance threshold, and determining whether the movement end position is within a preset end area; and
determining a correspondence between a current behavior of the target object and a target behavior type based on a determination that the movement distance is greater than or equal to the preset first distance threshold and the movement end position is within the preset end area; and
sending a notification associating the target behavior type with the target object based on the determined correspondence.

2. The method according to claim 1, wherein the determining the movement distance and the movement end position step comprises:
determining a movement start position and the movement end position of the target object within the preset area;
determining a first straight-line distance between the movement start position and the movement end position; and
setting the first straight-line distance as the movement distance of the target object within the preset area.

3. The method according to claim 2, wherein the determining the movement start position and the movement end position step comprises:
obtaining a movement trajectory of the target object within the preset area;
determining a corresponding movement start point and movement end point of the target object on the movement trajectory; and
determining the movement start point as the movement start position of the target object within the preset area; and
determining the movement end point as the movement end position of the target object within the preset area.

4. The method according to claim 1, wherein the preset first distance threshold is determined by:
determining a minimum distance between a preset start position and the preset end area, and designating the minimum distance as the preset first distance threshold, the preset start position being determined by responding to the setting of a start position of the target behavior type.

5. The method according to claim 1, wherein the determining whether the movement end position is within the preset end area step comprises:
determining an end position distance between the movement end position and a preset end position, the preset end position being determined by responding to setting of an end position of the target behavior type; and
determining that the movement end position is within the preset end area based on that the end position distance is less than or equal to a second distance threshold,
wherein the second distance threshold is determined by:
obtaining a historical movement end position;
determining a historical distance value between the historical movement end position and the preset end position; and
determining the second distance threshold according to the historical distance value.

6. The method according to claim 1, further comprising:
extracting, after an object is detected in a captured image, object features of the object in the captured image;
determining, according to the object features, whether a preset database stores the target object that matches the object features; and
determining a presence of the target object within the preset area based on that the preset database stores the target object matching the object features.

7. The method according to claim 6, further comprising:
recognizing physiological features of an object through a target camera module after a determination that the object enters the preset end area;
determining, according to the physiological features, whether the preset database stores the target object that matches the physiological features; and
determining a presence of the target object within the preset area after determining that the target object matches the physiological features.

8. The method according to claim 1, wherein the target behavior type comprises at least one of: a behavior of going home, a behavior of leaving home, a behavior of going to work, and an express delivery behavior.

9. An object behavior recognition method, comprising:
obtaining an image of a target object within a preset area;
determining a movement start position and a movement end position of the target object within the preset area according to the image; and
recognizing that a current behavior of the target object corresponds to a target behavior type based on a determination that the movement start position is within a preset start area and the movement end position is within a preset end area.

10. The method according to claim 9, wherein the determination that the movement start position is within the preset start area and the movement end position is within the preset end area comprises:
determining a start distance between the movement start position and a preset start position, and determining an end distance between the movement end position and a preset end position, wherein the preset start position is determined by responding to setting of a start position of the target behavior type, and the preset end position is determined by responding to setting of an end position of the target behavior type; and
determining that the movement start position is within the preset start area and the movement end position is within the preset end area based on that the start distance is less than a third distance threshold and the end distance is less than a fourth distance threshold.

11. The method according to claim 9, wherein the determining the movement start position and the movement end position step comprises:
obtaining a movement trajectory of the target object within the preset area from the obtained image;
determining a corresponding movement start point and movement end point of the target object based on the movement trajectory; and
determining the movement start point as the movement start position of the target object within the preset area, and determining the movement end point as the movement end position of the target object within the preset area.

12. The method according to claim 9, further comprising:
determining a preset start position and a preset end position of the target behavior type set for the obtained image;
determining a distance threshold corresponding to the target behavior type according to the preset start position and the preset end position; and
recognizing, according to the distance threshold and the preset end position, whether an object behavior corresponds to the target behavior type.

13. The method according to claim 12, wherein the determining the preset start position and the preset end position step comprises:
recognizing the preset start position and the preset end position in response to setting a preset icon in the obtained image.

14. The method according to claim 13, wherein the setting of the preset icon comprises a click operation, and the recognizing the preset start position and the preset end position step comprises:
after detecting at least two click operations on the obtained image:
setting the preset icon at a corresponding position of each click operation ; and
determining the preset start position and the preset end position according to a position of the preset icon; or
after detecting a drag operation on the preset icon:
determining a drag trajectory corresponding to the drag operation;
recognizing a drag start point and a drag end point of the drag trajectory; and determining the drag start point as the preset start position of the target behavior type set for the obtained image, and determining the drag end point as the preset end position of the target behavior type set for the obtained image.

15. The method according to claim 12, wherein the determining the preset start position and the preset end position step comprises:
obtaining an input video comprising a preset object having a behavior of the target behavior type within the preset area;
determining an appearance point and a disappearance point of the preset object in the input video; and
determining the appearance point as the preset start position of the target behavior type set for the obtained image, and determining the disappearance point as the preset end position of the target behavior type set for the obtained image.

16. The method according to claim 12, further comprising:
after determining the distance threshold corresponding to the target behavior type, determining an end area of the corresponding behavior of the target behavior type according to the preset end position, and determining, according to the distance threshold and the end area, whether the object behavior corresponds to the target behavior type.

17. The method according to claim 16, wherein the determining the end area of the corresponding behavior o step comprises:
determining whether the preset end position is located on a preset area object; and
determining the end area of the corresponding behavior of the target behavior type with the preset area object as a center after a determination that the preset end position is located on the preset area object; or
determining the end area of the corresponding behavior of the target behavior type with the preset end position as a center after a determination that the preset end position is not located on the preset area object.

18. The method according to claim 9, wherein the method further comprises:
obtaining a list of objects;
displaying the list of objects; and
determining a target object from the list of objects in response to an object selection operation on the list of objects; and
recognizing whether the behavior of the target object corresponds to the target behavior type.

19. The method according to claim 9, wherein the obtaining the image within the preset area step comprises:
obtaining a list of camera modules used for capturing the preset area;
displaying the list of camera modules;
determining a target camera module from the list of camera modules in response to a camera module selection operation on the list of camera modules; and
obtaining the image of the preset area by the target camera module.

20. An electronic device, comprising:
a processor,
a memory, and
a communication interface,
wherein the communication interface is configured to transmit data information through a local area network or a connection circuit, and the memory is configured to store the data information;
wherein the processor is configured to process the data information to:
generate information indicating a movement distance and a movement end position of a target object within a preset area;
generate, according to the information indicating the movement distance and the movement end position of the target object within the preset area, information for determining that a current behavior of the target object corresponds to a target behavior type; and
wherein the communication interface is further configured to send, to a terminal device, the information indicating the target behavior type.

21. The electronic device according to claim 20, further comprising a display interface,
wherein the processor is further configured to process the data information to generate information indicating a captured image of the preset area;
wherein the display interface is configured to:
display the information about the captured image of the preset area; and
receive information about a preset start position and a preset end position of the target behavior type set for the captured image;
wherein the processor is further configured to:
generate, according to the information about the preset start position and preset end position of the target behavior type set for the captured image, information for determining the preset start position and preset end position of the target behavior type set for the captured image; and
generate, according to the information indicating the preset start position and preset end position of the target behavior type set for the captured image, information used for indicating a distance threshold corresponding to the target behavior type; and
wherein the communication interface is further configured to send, to a camera or a base station, the information indicating the distance threshold and a threshold end position.
